(19) United States
(12) Patent Application Publication
(10) Pub. No.: US 2008/0261801 A1
(43) Pub. Date: Oct. 23, 2008

(54) Methods of Regenerating a Nox Absorbent

(75) Inventors: Jeremy Temple Gidney, Cambridge (GB); Martyn Vincent Twigg, Cambridge (GB)

Correspondence Address: RATNERPRESTIA, P O BOX 980, VALLEY FORGE, PA, 19482-0980, US

(73) Assignee: Johnson Matthey Public Limited Company, London (GB)

(21) Appl. No.: 11/630,018

(22) PCT Filed: Jun. 16, 2005
(86) PCT No.: PCT/GB2005/002375

§ 371 Date: Jan. 28, 2008

(30) Foreign Application Priority Data
Dec. 24, 2004 (GB) 0428291.9

(51) Int. Cl. B01J 38/48; B01D 53/96; F01N 3/10

(52) U.S. Cl. 502/22; 422/178; 60/299

(57) ABSTRACT

An exhaust system for a lean-burn internal combustion engine with at least one NOₓ-absorbent disposed on a unitary monolith substrate, an injector for injecting droplets of a liquid reductant into exhaust gas upstream of the at least one substrate and a means for controlling the injection of reductant in order to regenerate the NOₓ-absorbent to meet a relevant emission standard. The arrangement of the system being such that droplets of the liquid reductant contact the NOₓ-absorbent thereby causing localised reduction of NOₓ.

The present invention relates to an exhaust system for a lean-burn internal combustion engine such as a diesel engine comprising an absorbent for nitrogen oxides (NO). In particular the invention relates to a method of regenerating such a NOₓ-absorbent.

Exhaust systems for vehicular lean-burn internal-combustion engines comprising a device for absorbing nitrogen oxides (NOₓ) from lean exhaust gas and releasing the stored NOₓ in an atmosphere containing less oxygen for reduction to dinitrogen (N₂) are known from, for example, EP 0560991 (incorporated herein by reference). Such NOₓ-absorbents are typically associated with a catalyst for oxidising nitrogen monoxide (NO) to nitrogen dioxide (NO₂), e.g. platinum (Pt), and, optionally, also a catalyst such as rhodium, for reducing NOₓ to N₂ with a suitable reductant, e.g. a hydrocarbon. A catalyst comprising the NOₓ-absorbent and a NO oxidation catalyst and optional NOₓ reduction catalyst is often called a lean NOₓ-trap or simply a NOₓ-trap.

NOₓ-absorbents in a typical NOₓ-trap formulation can include compounds of alkali metals, e.g. potassium and/or caesium; compounds of alkaline earth metals, such as barium or strontium; and/or compounds of rare-earth metals, typically lanthanum and/or yttrium. One mechanism commonly given for NOₓ-storage during lean engine operation for this formulation is that, in a first step, the NO reacts with oxygen on active oxidation sites on the Pt to form NO₂. The second step involves adsorption of the NO₂ by the storage material in the form of an inorganic nitrate.

When the engine runs intermittently under enriched conditions, or the exhaust gas is at elevated temperatures, the nitrate species become thermodynamically unstable and decompose, producing NO or NO₂. Under enriched conditions, these NOₓ are reduced by carbon monoxide, hydrogen and hydrocarbons to N₂, which can take place over the reduction catalyst.

Whilst the inorganic NOₓ-storage component is typically present as an oxide, it is understood that in the presence of air or exhaust gas containing CO₂ and H₂O it may also be in the form of the carbonate or possibly the hydroxide. We also explain in our WO 00/21647 (incorporated herein by reference) that NOₓ-specific reactants can be used to regenerate a NOₓ-trap.

EP-B-0341832 (incorporated herein by reference) describes a process for combusting particulate matter (PM) in diesel exhaust gas, which method comprising oxidising NO in the exhaust gas to NO₂ on a catalyst, filtering the PM from the exhaust gas and combusting the filtered PM in the NO₂ at up to 400° C. Such a system is available from Johnson Matthey and is marketed as the CRT®.

EP 0758713A (incorporated herein by reference) discloses an exhaust system for a diesel engine, which system comprising a CRTO system as disclosed in EP-B-0341832, a heater for intermittently raising the exhaust gas temperature to react NO₂ with carbon collected on the filter and a NOₓ-absorbent or a lean NOₓ catalyst downstream of the CRT® filter for removing NO in the exhaust gas. The NOₓ-absorbent is regenerated, or reductant for reducing NO on the lean NOₓ catalyst is supplied, by introducing hydrocarbon fuel into the exhaust gas either during the exhaust stroke of one or more engine cylinders or by injecting the hydrocarbon fuel into the exhaust gas conduit between the engine and the oxidation catalyst.

The intention of injecting reductant into the exhaust gas upstream of a NOₓ-absorbent is to reduce the oxygen concentration of the exhaust gas, i.e. to enrich, but not necessarily to make rich (lambda <1), the exhaust gas composition. However, by injecting hydrocarbon reductant into the exhaust gas far upstream of the NOₓ-absorbent, droplets of the liquid hydrocarbon reductant evaporate. Furthermore, at full gas flow, a significant amount of reductant is required merely to remove all the excess oxygen (through combustion) before any degree of richness is obtained. Where the reductant is a hydrocarbon fuel such as Diesel, this approach is costly on fuel economy.

We have found that by deliberately restricting evaporation of injected fluid reductant, e.g. hydrocarbon fuel, by introducing controlled size droplets of reductant close to the upstream face of a substrate monolith carrying a NOₓ-absorbent, liquid droplets of reductant can contact the NOₓ-absorbent. Where they do, the environment is strongly reducing and this can reduce stored nitrate in the vicinity. Hence, this arrangement can significantly reduce the consumption of reductant associated with NOₓ-absorbent regeneration.

According to a first aspect, the invention provides an exhaust system for a lean-burn internal combustion engine comprising at least one NOₓ-absorbent disposed on a unitary monolith substrate, means comprising an injector for injecting droplets of a liquid reductant into exhaust gas upstream of the at least one substrate and means, when in use, for controlling the injection of reductant in order to regenerate the NOₓ-absorbent thereby to meet a relevant emission standard, the arrangement being such that droplets of the liquid reductant contact the NOₓ-absorbent thereby causing localised reduction of NOₓ.

The skilled person is well aware of techniques for controlling the droplet size of reductants in exhaust systems of internal combustion engines and the appropriate equipment can be selected for the desired purpose. Parameters for consideration include selection of appropriate pressure for delivering the reductant to the injector head, which can use common-rail fuel injectors in diesel engines, and modulating the pressure depending on engine speed and/or gas hourly space velocity of exhaust gas in the system. Design of injector heads is well known from parallel arts and can adopt use of electrostatic spray techniques, or aspects of technology from fuel burners for household boilers etc. Whatever arrangement is selected, the overriding feature of the invention is that the reductant contacts the NOₓ-absorbent in the form of droplets of liquid reductant.

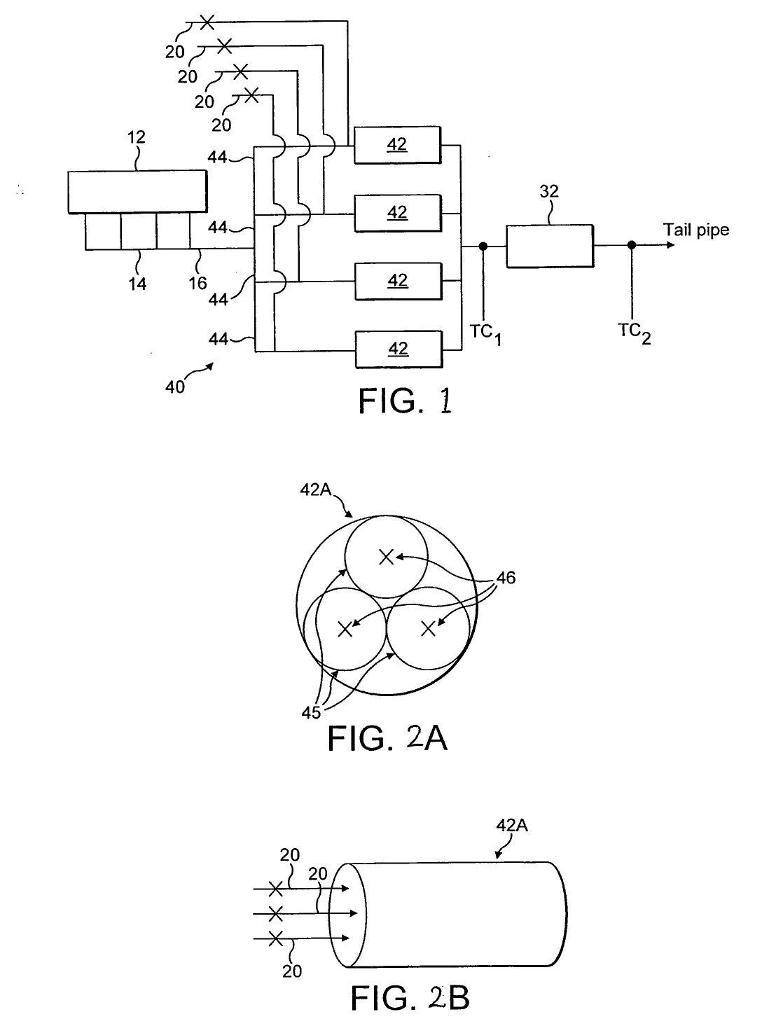

In one embodiment, shown in FIG. 1, the exhaust system comprises a plurality of NOₓ-absorbents disposed on unitary monolith substrates arranged in parallel, each substrate associated with a reductant injector and means, when in use, for successively contacting at least one of the parallel substrates with droplets of liquid reductant whilst the plurality of NOₓ-absorbents remain in-line to exhaust gas flow. The gas hourly space velocity (GHSV) over each NOₓ-trap is dependent on the relative backpressure in each line, but normally the system will be set up so that the arrangement is the same in each, in which case the GHSV will be substantially the same in each line. In one regeneration technique, NOₓ-absorbent regeneration is conducted in series in the NOₓ-absorbents in the system, i.e. at any instant, at least one line is not having reductant injected, so that when the exhaust gas exiting all NOₓ-traps in the system is mixed, its composition is lean, i.e. lambda >1.

In a second embodiment, shown in FIGS. 2A and 2B, an upstream end of the at least one substrate is subdivided in the direction of fluid flow into at least two zones and the system comprises means, when in use, for contacting successively a fraction of the at least two zones with droplets of liquid reductant whilst the at least one substrate as a whole remains in-line to exhaust gas flow. An advantage of this embodiment is that less space is required on a vehicle comprising the exhaust system to accommodate the system compared with systems comprising a plurality of substrate monoliths each comprising a NOₓ-absorbent.

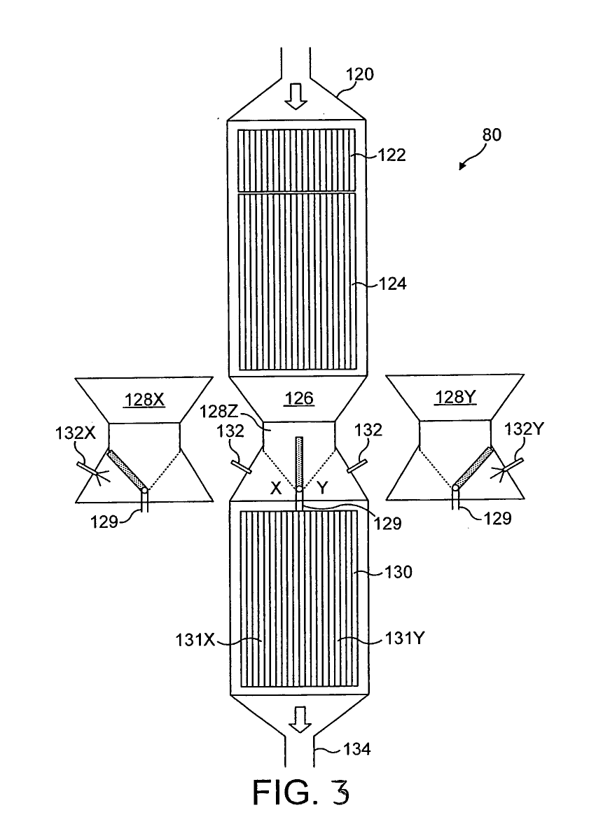

In one arrangement of this second embodiment, shown in FIG. 3 the means for contacting the fraction of the at least two zones with droplets of liquid reductant comprises a flap valve disposed at the upstream end of the substrate. A single injector upstream of the flap valve can be used with a majority of the injected reductant being directed to a particular zone by actuation of the flap valve. Alternatively, each zone divided by the flap valve can be associated with its own injector. Reduced exhaust gas flow in the fraction receiving reductant can promote NOₓ absorbent regeneration and can be effected by flap valve actuation.

The exhaust system of the first or second embodiment can include means for controlling, by positive feed-back, reductant injection in order to prevent unnecessary slip of hydrocarbon reductant to atmosphere. The control means comprises an oxidation catalyst for oxidising the reductant disposed downstream of the or each NOₓ-absorbent substrate, means for determining a temperature difference (ΔT) across the oxidation catalyst and means, when in use, for controlling injection of droplets of liquid reductant, wherein the reductant droplet injection control means controls the rate of reductant injection to maintain ΔT within a pre-determined range, wherein the system is configured so that the exhaust gas composition over the oxidation catalyst is lean.

In one embodiment of an exhaust system comprising the means for controlling reductant injection, wherein the rate of reductant injection is decreased if ΔT is too large.

The NOₓ-absorbent for use in the present invention can comprise at least one alkali metal, alkaline earth metal or rare-earth metal or a mixture of any two or more thereof. Suitable alkali metals can be selected from the group consisting of potassium and caesium; efficacious alkaline-earth metals can be selected from the group consisting of magnesium, calcium, strontium and barium; and the rare-earth metal can be one or both of lanthanum and yttrium.

In embodiments, the NOₓ-absorbent can comprise a catalyst for oxidising nitrogen monoxide, optionally a platinum group metal such as platinum and can further comprise a catalyst for reducing NOₓ to N₂, such as rhodium.

In a particular embodiment, the control means, when in use, injects reductant only when the NOₓ reduction catalyst is active.

Unless otherwise described, the catalysts for use in the present invention are coated on high surface area substrate monoliths made from metal or ceramic or silicon carbide, e.g. cordierite, materials. A common arrangement is a honeycomb, flowthrough monolith structure of from 100-600 cells per square inch (cpsi) such as 300-400 cpsi (15.5-93.0 cells cm⁻², e.g. 46.5-62.0 cells cm⁻²).

Particle dynamics can cause the droplets of liquid reductant to pass through a conventional flow-through ceramic or metal monolith substrate without impinging on the NOₓ-absorbent carried on the walls thereof. In order to increase the possibility of the reductant contacting the NOₓ-absorbent, in one embodiment a foam substrate comprising a ceramic or metal foam is used. An alternative embodiment utilises metallic partial filter substrates including internal baffles, such as disclosed in EP-A-1057519 or WO 03/038248 (both incorporated herein by reference). According to a further embodiment, the NOₓ-absorbent comprises a conventional ceramic wall-flow filter; here pressure-drop driven convention should ensure that reductant droplets contact stored NOₓ. In this latter embodiment, efficient filtration of PM per se is not important so porous filters could be used, but combined NOₓ and PM control would be desirable as described in JP-B-2722987 (JP-A-06-159037) (incorporated herein by reference), i.e. the filter includes a soot combustion catalyst/NO oxidation catalyst e.g. Pt, a NOₓ-absorbent such as barium oxide and, optionally, a NOₓ reduction catalyst e.g. rhodium.

In another embodiment the or each NOₓ-absorbent substrate monolith comprises a particulate filter.

Advantage can also be made of particle dynamics when an oxidation catalyst is coated on a conventional flow-through monolith and is disposed between the reductant injector and the NOₓ-absorbent substrate. Depending on the open-frontal area and cell density of the monolith, reductant droplets can pass through the oxidation catalyst substantially without oxidation and be available for reducing stored NOₓ in the NOₓ-absorbent. Evaporated hydrocarbon reductant, i.e. gaseous hydrocarbon, is more likely to be oxidised on an oxidation catalyst.

In a particular arrangement, the NOₓ reduction catalysts and systems for delivering reductant described herein are disposed downstream of the arrangement described in EP-B-0341832, mentioned hereinabove.

According to a second aspect, the invention provides a vehicle comprising an exhaust system according to the invention.

The internal combustion engine can be a diesel or lean-burn gasoline engine, such as a gasoline direct injection engine. The diesel engine can be a light-duty engine or a heavy-duty engine, as defined by the relevant legislation.

According to a third aspect, the invention provides a method of regenerating a NOₓ-absorbent disposed on a unitary monolith substrate in the exhaust system of a lean-burn internal combustion engine, which method comprising contacting the NOₓ-absorbent with droplets of a liquid reductant thereby causing localised reduction of NOₓ.

According to one embodiment wherein the exhaust system comprises a plurality of NOₓ-absorbents disposed on unitary monolith substrates arranged in parallel, the method comprises contacting successively at least one of the parallel substrates with droplets of liquid reductant whilst the plurality of NOₓ absorbents remain in-line to exhaust gas flow.

In another embodiment, the method comprises contacting successively a fraction of a single substrate with the liquid reductant droplets while the substrate as a whole remains in-line to exhaust gas flow. Where only a fraction of a single substrate is contacted with the reductant, this can be done at reduced exhaust gas flow.

In a particular embodiment, the method provides the step of oxidising the reductant over an oxidation catalyst located downstream of the NOₓ-absorbent substrate, determining the difference between the inlet and the outlet temperatures (ΔT) of the oxidation catalyst and adjusting the rate of reductant injection so that ΔT is within a pre-determined range.

Desirably, wherein the NOₓ-absorbent comprises a catalyst for reducing NOₓ to N₂, the method comprises contacting the or each substrate with liquid reductant droplets only when the NOₓ reduction catalyst is active for catalysing NOₓ reduction.

In order that the present invention may be more fully understood, embodiments thereof will be described with reference to the accompanying drawings, in which:

FIG. 1 is a schematic of one embodiment of an exhaust system according to the invention;

FIG. 2A is a schematic of another embodiment of an exhaust system according to the invention showing an end-on view of a NOₓ-trap comprising a unitary substrate monolith showing the injection points and spray zones of multiple reductant injectors at the upstream end of the substrate;

FIG. 2B is a schematic side view of the unitary substrate monolith shown in FIG. 2A;

FIG. 3 is a schematic sectional view of an embodiment of another exhaust system embodiment of the invention including a NOₓ-trap in combination with a soot combustion reactor for use in treating the exhaust gas of a diesel engine;

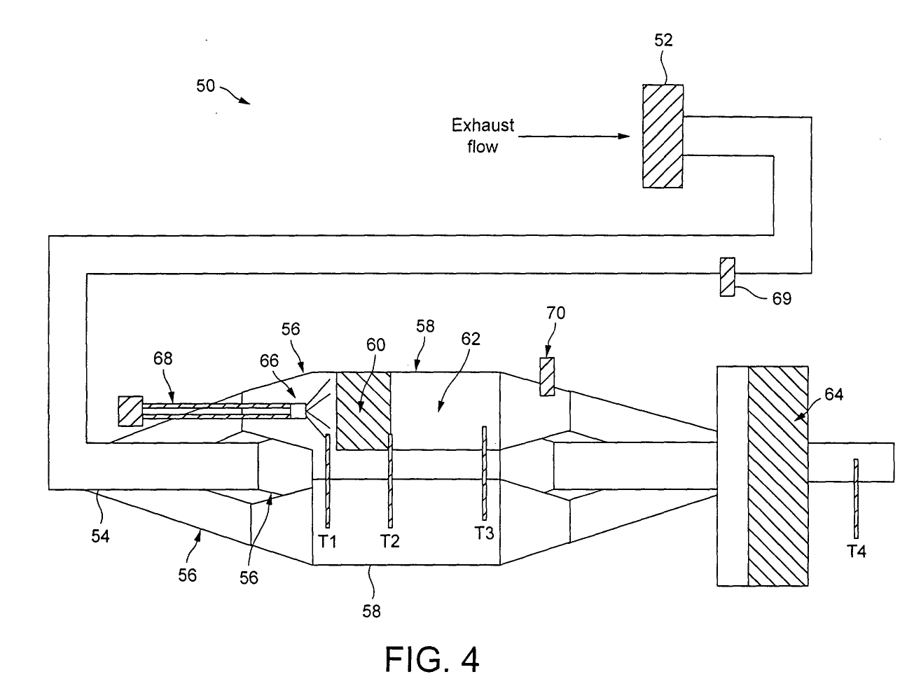

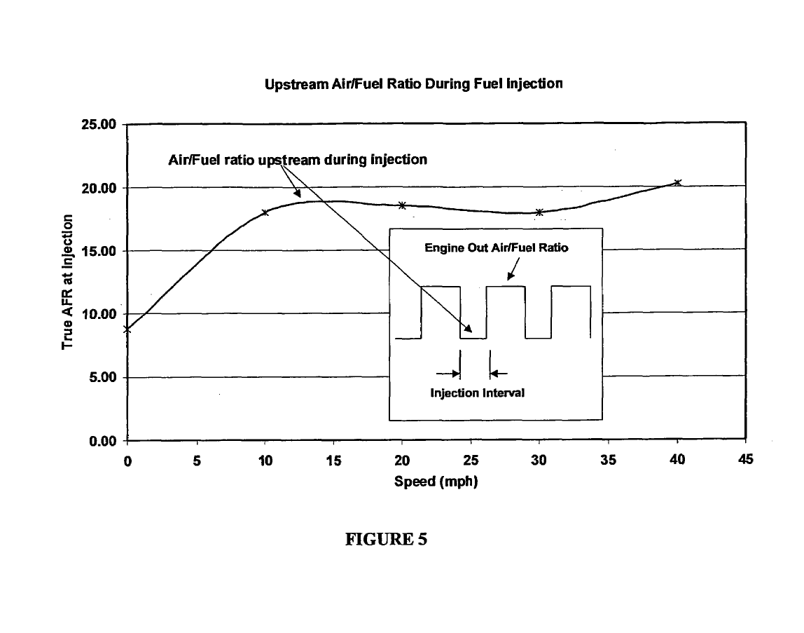

FIG. 4 is a schematic of a working exhaust system embodiment of the invention;

FIG. 5 is a graph showing the upstream Air/Fuel Ratio (AFR) as a function of road speed in the embodiment of FIG. 4;

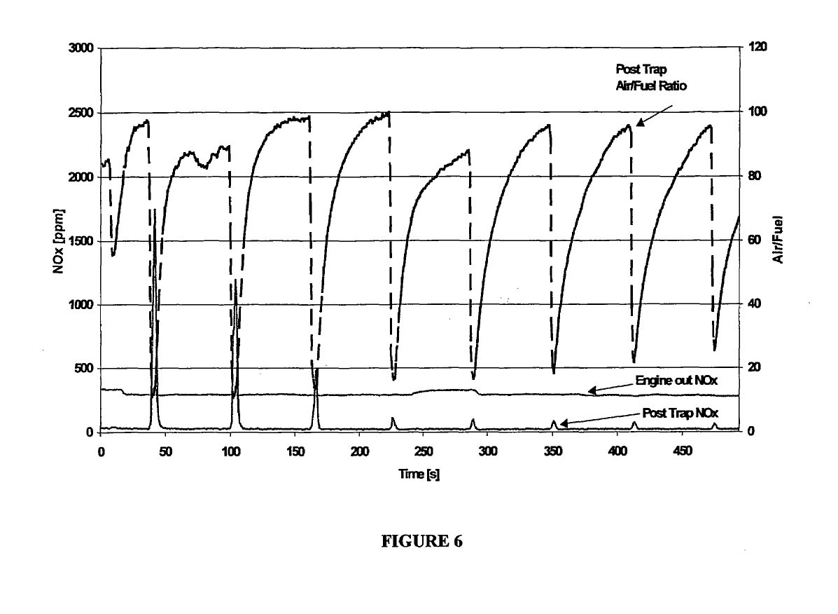

FIG. 6 is a graph showing NOₓ measurements at the idle condition for the embodiment of FIG. 4;

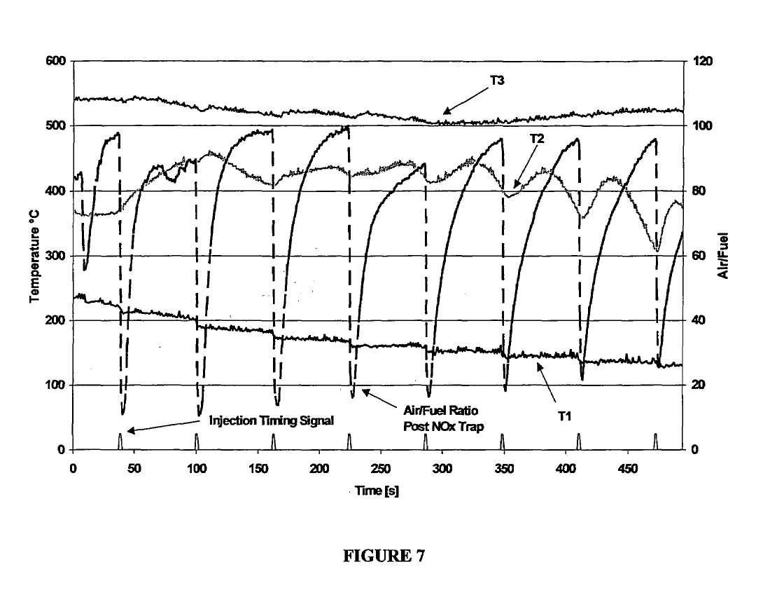

FIG. 7 is a graph showing the corresponding system temperatures at the idle condition for the trace shown in FIG. 6;

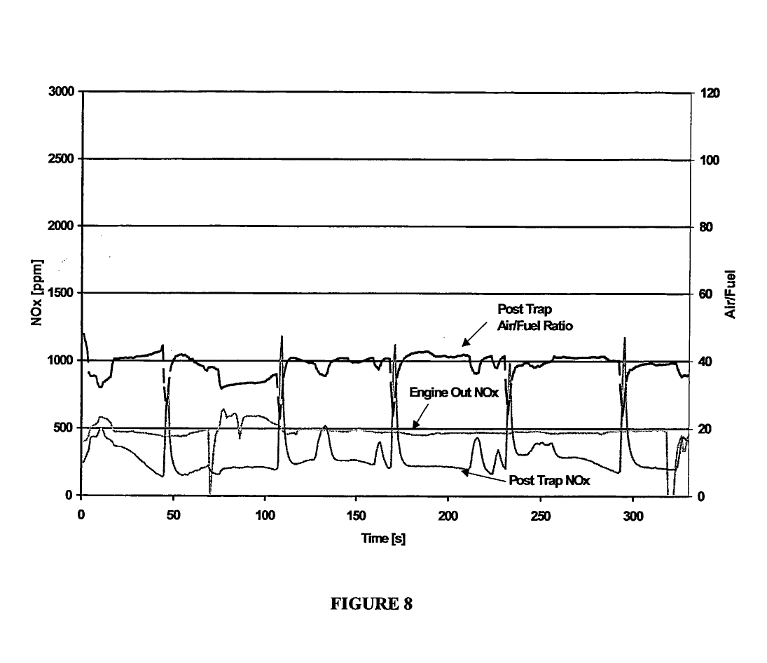

FIG. 8 is a graph showing NOₓ measurements at 40 mph for the embodiment of FIG. 4;

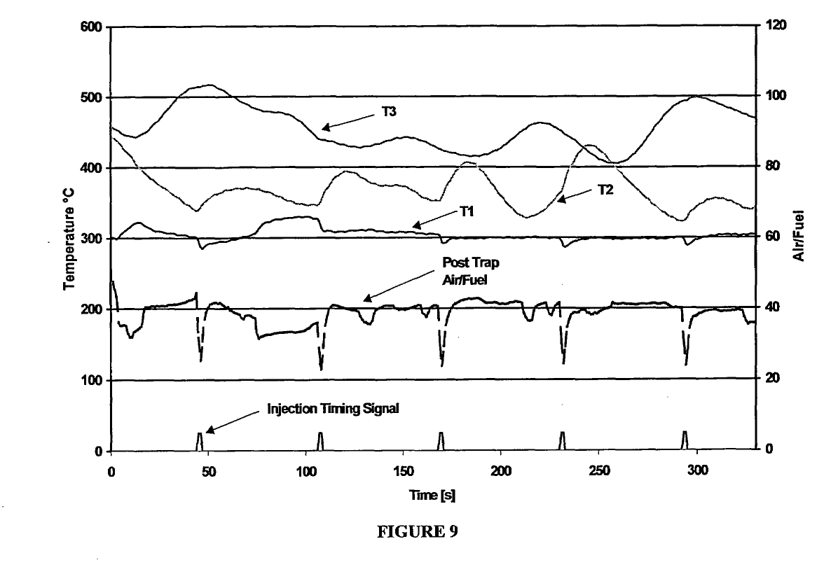

FIG. 9 is a graph showing the corresponding temperature measurements at 40 mph for the trace shown in FIG. 8; and

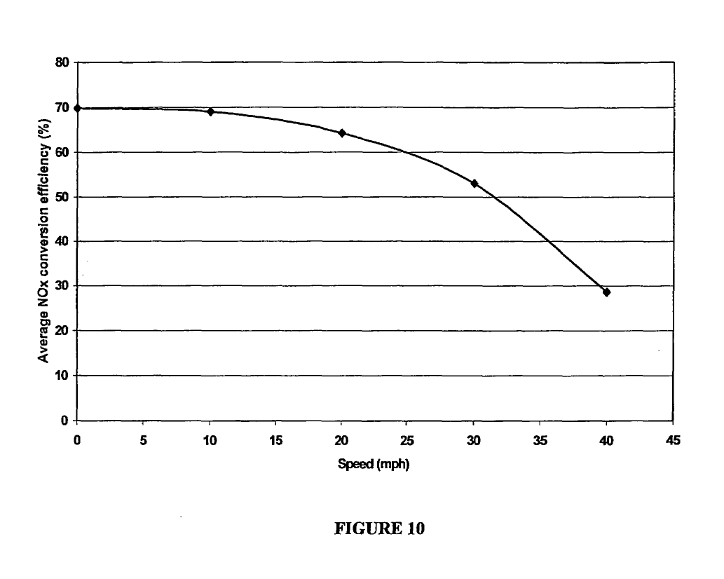

FIG. 10 is a graph showing the NOₓ conversion as a function of road speed for the system of FIG. 4.

An exhaust system, generally referenced as 40, according to an embodiment of the invention is shown in FIG. 1, wherein 12 represents a diesel engine, 14 the exhaust manifold, 16 the exhaust line and 42 multiple NOₓ-trap catalysts comprising Pt/Rh and BaO supported on an alumina washcoat each on a substrate monolith and arranged in parallel exhaust lines 44, each line having its own reductant supply means 20 including an injector for injecting a quantity of diesel fuel into the exhaust line 16 upstream of NOₓ-trap catalysts 42. Oxidation catalyst 32, e.g. 1 wt % platinum supported on a gamma-alumina washcoat, is located downstream of the downstream join of exhaust lines 44. Thermocouple TC1 detects the temperature of the exhaust gas at the inlet to TC1 and a second thermocouple TC2 is located downstream of oxidation catalyst 32 to detect the temperature of exhaust gas at the outlet thereto. TC1 and TC2 relay the detected temperatures to a processor in the engine control unit (ECU (not shown)).

In use, the system is operated in such a way as to ensure the gas is always lean over the oxidation catalyst 32. For example, at any one time, at least one line is not having reductant injected, so when the total NOₓ-trap 42 exit gas streams are mixed, the resulting gas is overall lean before passing over the downstream oxidation catalyst 32. No reductant is injected below a certain critical exhaust gas temperature, at which the NOₓ-trap catalyst is below its light-off temperature for catalysing NOₓ reduction. Above this temperature, increasing the amount of reductant causes increasing amounts of NOₓ in the exhaust gas to be reduced. Small excess reductant slip is oxidised over oxidation catalyst 32 and the resulting exotherm results in a temperature increase across the catalyst as measured by the difference in temperatures detected at TC2 and TC1, i.e. ΔT=TC2−TC1. The control strategy is to adjust the rate of reductant addition to keep the measured ΔT at substantially a pre-determined value corresponding to optimum NOₓ removal. The reductant flow is increased if ΔT is too small, or decreased if ΔT is larger than desired for optimum efficient NOₓ conversion.

Another embodiment is shown in FIGS. 2A and 2B, wherein the plurality of parallel NOₓ-traps 42 of the FIG. 1 embodiment are replaced by a single unitary NOₓ-trap 42A and three reductant supply means 20 are disposed equidistantly at the upstream end of the NOₓ-trap substrate monolith and directing a reductant spray onto juxtaposed zones 45 on the front face of the substrate monolith whose centres are defined by injection points 46. This arrangement provides the same overall effect as the embodiment illustrated in FIG. 1 but using a larger single, i.e. unitary NOₓ-trap substrate equipped with two or more reductant injectors. The injectors can be operated in a sequential manner so at any one time only part of the NOₓ-trap is undergoing regeneration, and exit gas from this part is mixed with exhaust gas from parts not being regenerated to provide an overall lean gas stream for oxidation on catalyst 32.

Referring to a further embodiment shown in FIG. 3, an exhaust gas aftertreatment system 80 comprises a soot combustion reactor 120 the inlet of which is connected to the exhaust manifold of a diesel engine (not shown). Reactor 120 at its upstream portion contains oxidation catalyst 122 consisting of a ceramic honeycomb carrying an alumina-based washcoat and Pt. At its downstream portion reactor 120 contains wall-flow filter 124, consisting of filter-grade ceramic honeycomb, the passages of which are alternately plugged and unplugged at the inlet end and alternately plugged at the outlet end, wherein passages plugged at the inlet end are unplugged at the outlet end, and vice versa. Such an arrangement of oxidation catalyst for oxidising NO to NO₂ for combustion of PM on a downstream filter is described in EP-B-0341832 and the arrangement is known as the CRT®. From the outlet end of reactor 120 plenum 126 continues as the operating chamber of flap valve 128X,Y,Z at the inlet of NOₓ-trap vessel 130. Vessel 130 contains NOₓ-trap 131X,Y consisting of a flowthrough ceramic honeycomb monolith substrate carrying an alumina washcoat containing barium oxide and metallic Pt and Rh. The fulcrum of flap valve 128X,Y,Z is mounted on partition 129 which extends diametrically across the face of reactor 130 and is gas-tightly sealed to the face of NOₓ-trap 131. Each region X,Y of reactor 130 either side of valve 128 is provided with reactant injector 132X,Y. In the complete reactor 130 as shown, valve 128 is in the central position Z. Valve positions X and Y are shown as insets. Reactor 130 is formed with outlet 134, leading to atmosphere or to further treatment. Preferably, rates of flow in the two halves of reactor 130 are controlled to give a net lean composition and the mixture is passed over an oxicat, in the arrangement shown in FIG. 1.

In the normal operation of the system, the exhaust gas, comprising steam (H₂O (g)), dinitrogen (N₂), oxygen (O₂), carbon dioxide (CO₂), unburned hydrocarbon fuel (HC), carbon monoxide (CO), nitrogen oxides (NOₓ) and particulate matter (PM), at e.g. 300° C. contacts catalyst 122 over which NO is oxidised to NO₂ and some of the HC and CO are oxidised to steam and CO₂. It then enters filter 124 on which most of the PM is collected and combusted by reaction with the NO₂ formed in catalyst 122 and possibly with O₂. The PM-freed gas then undergoes treatment in one of the 3 modes: 128Z: NOₓ-trap regions 130x and 130Y both absorb (or adsorb) NOₓ; 128X: region 131X receives a small fraction of the gas leaving plenum 126 and injection of diesel fuel at 132X. It undergoes regeneration, and its effluent is reunited with that of region 130Y; region 131Y receives the major portion of the gas, absorbs NOₓ and passes its effluent to atmosphere at 134; 128Y: region 131Y performs the duty described at 128X.

The engine management system (not shown) changes from region X to region Y when NOₓ-trap 131Y has free capacity to absorb NOₓ; and vice versa.

The following Example is provided by way of illustration only.

### EXAMPLE

The exhaust system (50) (shown in FIG. 4) of a single deck bus fitted with a 6 litre turbocharged engine and comprising engine turbo (52), type approved to European Stage 1 emission limits, was modified to incorporate a three-way splitter (54) for diverting the exhaust gas into one of three parallel legs (56), the exhaust gas flow in each leg being of equal velocity flow. Each leg (56) comprised a chamber (58) containing an oxidation catalyst (60) followed by a NOₓ-trap (62). The gas flows were then combined downstream of the NOₓ-traps and the total exhaust gas flow was passed through a “clean up” oxidation catalyst (64) to remove any unburned hydrocarbons (HC) exiting the NOₓ-traps before the exhaust gas was passed directly to the atmosphere. A fuel injector (66) comprising a fuel solenoid (68) was sited in front of each oxidation catalyst (60), a NOₓ sensor (69) in front of the exhaust splitter (54), combined NOₓ/air fuel ratio sensors (70) behind the NOₓ-traps and thermocouples (T1, T2, T3, T4) measuring temperatures in front of and behind the oxidation catalysts (60) and at the exit of the reactors. The oxidation catalysts (60) and the NOₓ traps (62) were each coated on ceramic flow-through monoliths at 400 cells in⁻² (62 cells cm⁻²) and 0.06 in (0.15 mm) wall thickness. The oxidation catalysts (60) were 5.66 in (144 mm) diameter×3 in (76 mm) and volume 75.5 in³ (1.24 litre), the NOₓ-traps (62) were the same diameter but 6 in (152 mm) long and the “clean up” catalyst (64) 10.5 in (267 mm) diameter×3 in (76 mm) long and volume 260 in³ (4.26 litres).

The experiments described here were conducted using one leg of the split exhaust only. The vehicle was operated using diesel fuel containing 50 ppm sulphur and run at steady speeds of idle, 10, 20, 30 and 40 mph for periods of time; fuel was injected at each of these points and the air fuel ratio during injection determined as shown in FIG. 5. The combination of time and duration (2 seconds injection, one per minute per leg) was selected empirically as it gave the best combination of exhaust gas temperatures (to maintain the NOₓ-trap within an active temperature window) and NOₓ conversion. Simultaneously the NOₓ emissions pre- and post- the system together with the temperature profiles were measured.

In FIG. 5, the square wave represents the idealised air/fuel ratio after the injector and before the front face of the catalyst. The exhaust gas mixture is normally lean, but becomes instantaneously richer during injection. The calculated ‘rich’ air/fuel ratio (on the basis of the fuel volume injected, exhaust stoichiometry and exhaust flow rate) as a function of road speed is represented by the curve. It was found that, if the stoichiometric air/fuel ratio is 14.7:1, then the injector was unable to create a truly rich mixture at speeds greater than about 6 mph. The measured air/fuel ratio used in later Figures is taken from a post-NOₓ-trap sensor. Because of the absorption and chemical activity within the catalyst system, the well-defined shape of the square wave is lost.

FIG. 6 shows the NOₓ emissions (ppm) from the engine and after the NOₓ-trap for the idle condition together with the air fuel ratio measured after the NOₓ-trap. FIG. 7 shows the temperature traces for the same period. From FIG. 6 it is seen that when fuel is injected at the start of the idle period, the air fuel ratio drops from lean to rich as expected from the predictions in FIG. 5 and, after the initial NOₓ breakthrough, good NOₓ conversion is seen. With time, the air fuel ratio remains lean throughout the injection event but good NOₓ conversion is still maintained. The exotherm (T2) generated over the oxidation catalyst helps maintain the temperature of the NOₓ-trap within its operating window of 220-550° C. An exotherm (T3) is also registered across the NOₓ-trap, some of which is caused by combustion of unreacted gaseous reductant from the oxidation catalyst. We interpret this result to mean that some of this exotherm is from the combustion of unburned fuel droplets reacting on the surface of the NOₓ-trap as time increases at this engine idle condition. This is because the system inlet temperature falls so as to be insufficient to vaporise the incoming fuel and the rear sensor measured air/fuel ratio spikes become less pronounced and more rounded, suggesting a sequence of the deposition, vaporisation and then the subsequent oxidation of the fuel droplets. The local richness caused by this event also serves to maintain the observed NOₓ-trap operation efficiency.

The results of the experiment with the bus held at a steady speed of 40 mph are shown in FIGS. 8 and 9. Here the exhaust flow rate was much higher but the same injection flow rate was used as at idle and the exhaust was expected to remain lean throughout the injection periods (FIG. 5). However, apart from the breakthrough spikes when the fuel is first injected, NOₓ is reduced over the remaining operating time, although not as efficiently as at idle. The exotherm (T3) over (T2) was sometimes lower than at idle, but because of the heat capacity of the increased flow rate of exhaust gases, it is very significant. Therefore an exothermic reaction is still taking place and again we believe that this is because some unburned fuel droplets are being carried through the oxidation catalyst and being combusted on the NOₓ-trap. The persistence of fuel droplets, despite the higher inlet temperature of the oxidation catalyst, is expected to occur because the greater exhaust flow rate that is likely to carry the droplets through the oxidation catalyst as is shown by the significant exotherm measured across the NOₓ-trap and the trap regeneration observed in apparently lean conditions.

FIG. 10 presents the trend in calculated average NOₓ conversion efficiency, as a function of speed, for the system. FIG. 5 indicates rich exhaust gas conditions do not occur above about 6 mph but good NOₓ conversions were obtained under lean conditions across a wider speed range. This is especially relevant in the range from idle to 30 mph which is the most common operating range for an urban city bus.

1. An exhaust system for a lean-burn internal combustion engine comprising at least one NOₓ-absorbent disposed on a unitary monolith substrate, means comprising an injector for injecting droplets of a liquid reductant into exhaust gas upstream of the at least one substrate and means, when in use, for controlling the injection of reductant in order to regenerate the NOₓ-absorbent thereby to meet a relevant emission standard, the arrangement being such that droplets of the liquid reductant contact the NOₓ-absorbent thereby causing localised reduction of NOₓ, wherein the exhaust system comprises either:
(i) a plurality of NOₓ-absorbents disposed on unitary monolith substrates arranged in parallel, each substrate associated with a reductant injector and means, when in use, for successively contacting at least one of the parallel substrates with droplets of liquid reductant whilst the plurality of NOₓ-absorbents remain in-line to exhaust gas flow; or
(ii) a single monolith substrate, an upstream end of which substrate is subdivided in the direction of fluid flow into at least two zones and means, when in use, for contacting successively a fraction of the at least two zones with droplets of liquid reductant whilst the substrate as a whole remains in-line to exhaust gas flow.

2. (canceled)

3. (canceled)

4. An exhaust system according to claim 1, wherein in arrangement (ii) the means for contacting the fraction of the at least two zones with droplets of liquid reductant comprises a flap valve disposed at the upstream end of the substrate.

5. An exhaust system according to claim 1, wherein in arrangement (ii) a separate injector is associated with each zone.

6. (canceled)

7. (canceled)

8. An exhaust system according to claim 1, wherein the NOₓ-absorbent comprises a compound of at least one alkali metal, alkaline earth metal or rare-earth metal or a mixture of any two or more thereof.

9. An exhaust system according to claim 8, wherein the alkali metal is potassium or caesium.

10. An exhaust system according to claim 8, wherein the alkaline-earth metal is selected from the group consisting of magnesium, calcium, strontium and barium.

11. An exhaust system according to claim 8, wherein the rare-earth metal is selected from the group consisting of lanthanum and yttrium.

12. An exhaust system according to claim 1, wherein the NOₓ-absorbent comprises a catalyst for oxidising nitrogen monoxide.

13. An exhaust system according to claim 12, wherein the NOₓ-absorbent comprises a catalyst for reducing NOₓ to N₂.

14. An exhaust system according to claim 12, comprising control means, when in use, to inject reductant only when the NOₓ reduction catalyst is active.

15. An exhaust system according to claim 1, wherein the NOₓ-absorbent substrate monolith comprises a ceramic or metal foam.

16. An exhaust system according to claim 1, wherein the NOₓ-absorbent substrate monolith comprises a particulate filter.

17. An exhaust system according to claim 1, comprising an oxidation catalyst located between the injector and the NOₓ-absorbent substrate monolith.

18. A vehicle comprising an exhaust system according to claim 1.

19. A vehicle according to claim 18 comprising a diesel engine.

20. A method of regenerating a NOₓ-absorbent disposed on a unitary monolith substrate in the exhaust system of a lean-burn internal combustion engine, which method comprising contacting the NOₓ-absorbent with droplets of a liquid reductant thereby causing localised reduction of NOₓ, wherein either:
(a) the exhaust system comprises a plurality of NOₓ-absorbents disposed on unitary monolith substrates arranged in parallel, and the method comprises contacting successively at least one of the parallel substrates with droplets of liquid reductant whilst the plurality of NOₓ absorbents remain in-line to exhaust gas flow; or
(b) the exhaust system comprises a single monolith substrate and the method comprises contacting successively a fraction of the substrate with the liquid reductant droplets while the substrate as a whole remains in-line to exhaust gas flow.

21. (canceled)

22. (canceled)

23. A method according to claim 20, wherein in alternative (b) the step of contacting successively the fraction of the substrate with the liquid reductant droplets occurs at reduced exhaust gas flow.

24. (canceled)

25. A method according to claim 20, wherein the NOₓ-absorbent comprises a catalyst for reducing NOₓ to N₂, which method comprising contacting the or each NOₓ-absorbent substrate with liquid reductant droplets only when the NOₓ reduction catalyst is active for catalysing NOₓ reduction.

26. A method according to claim 20, wherein the reductant comprises a hydrocarbon, such as the fuel that powers the engine.

27. An exhaust system according to claim 12, wherein the catalyst for oxidizing nitrogen monoxide is a platinum group metal.

28. An exhaust system according to claim 27, wherein the platinum group metal is platinum.

29. An exhaust system according to claim 13, wherein the catalyst for reducing NOₓ to N₂ is rhodium.

30. The method according to claim 26, wherein the hydrocarbon is a fuel that powers the lean-burn internal combustion engine.
